(19) United States
(12) Patent Application Publication
(10) Pub. No.: US 2005/0218654 A1
(43) Pub. Date: Oct. 6, 2005

(54) Inside coupling and cap for corrugated conduits

(76) Inventor: Carl Diez, Sabrevoix (CA)

Correspondence Address: BIRCH STEWART KOLASCH & BIRCH, PO BOX 747, FALLS CHURCH, VA, 22040-0747, US

(21) Appl. No.: 10/815,735

(22) Filed: Apr. 2, 2004

(51) Int. Cl. F16L 33/00

(52) U.S. Cl. 285/397; 285/370; 285/901; 285/903

(57) ABSTRACT

The present invention relates to a staple for holding a tubular member within a corrugated conduit, wherein the tubular member comprises an outer surface, and the corrugated conduit comprises an open end and an inner surface with successive and alternating annular peaks and valleys. The staple comprises a mechanically compliant convex wall slanted in a direction opposite to a direction of insertion of the tubular member in the corrugated conduit through the open end of this corrugated conduit. The latter mechanically compliant convex wall includes: an elongated wall base connected to the outer surface of the tubular member; a sloping convex surface for sliding over the annular peaks and valleys upon inserting the tubular member in the corrugated conduit through the open end of this corrugated conduit; and a free edge for engaging the inner surface of the corrugated conduit and thereby locking the tubular member inside the corrugated conduit when the mechanically compliant convex wall has been inserted in one of the valleys of the inner surface of the corrugated conduit. The present invention is further concerned with an inside cap for closing an open end of a corrugated conduit, and with a coupling for interconnecting first and second corrugated conduits both incorporating the above described staple.

### FIELD OF THE INVENTION

The present invention relates to an inside coupling and cap for corrugated conduits.

### BACKGROUND OF THE INVENTION

Corrugated conduits, in particular perforated corrugated conduits made of plastic material are commonly used for subsurface applications such as domestic, agricultural and industrial drainage, and waste disposal systems. The corrugations reinforce these perforated plastic conduits to prevent them to collapse when they are buried in the soil.

Conventional corrugated conduits are usually cut into lengths or rolled on large drums. When installed in the field, lengths of corrugated conduits often have to be connected end to end. Ends of corrugated plastic conduit also have to be closed.

Couplings or caps presently available on the market to either connect lengths of corrugated plastic conduits end to end or to close ends of corrugated plastic conduit suffer from the same deficiency; they are difficult to install in the field. Since these couplings and caps often have to be installed in trenches dug into the ground, the bad work environment requires couplings and caps as easy to install as possible.

A need therefore exists for couplings and caps made as easy to install as possible, even in bad work environments.

### SUMMARY OF THE INVENTION

Therefore, according to the invention, there is provided a staple for holding a tubular member within a corrugated conduit. The tubular member comprises an outer surface, the corrugated conduit comprises an open end and an inner surface with successive and alternating annular peaks and valleys, the staple comprises a mechanically compliant convex wall slanted in a direction opposite to a direction of insertion of the tubular member in the corrugated conduit through the open end of this corrugated conduit, and the mechanically compliant convex wall comprises: an elongated wall base connected to the outer surface of the tubular member; a sloping convex surface for sliding over the annular peaks and valleys upon inserting the tubular member in the corrugated conduit through the open end of this corrugated conduit; and a free edge for engaging the inner surface of the corrugated conduit and thereby locking the tubular member inside the corrugated conduit when the mechanically compliant convex wall has been inserted in one of the valleys of the inner surface of the corrugated conduit.

The present invention also relates to an inside cap for closing an open end of a corrugated conduit with an inner surface having successive and alternating annular peaks and valleys. The inside cap comprises a tubular member defining a geometrical longitudinal axis, having an outer surface, a proximal end and a distal end, closed by a wall perpendicular to the geometrical longitudinal axis, and provided with at least one staple. The staple comprises a mechanically compliant convex wall slanted toward the distal end of the tubular member and having: an elongated wall base connected to the outer surface of the tubular member; a sloping convex surface for sliding over the annular peaks and valleys upon inserting the tubular member in the corrugated conduit through the open end of that corrugated conduit; and a free edge for engaging the inner surface of the corrugated conduit and thereby locking the tubular member inside the corrugated conduit when the mechanically compliant convex wall has been inserted in one of the valleys of the inner surface of the corrugated conduit.

Further in accordance with the present invention, there is provided a coupling for interconnecting first and second corrugated conduits each having an open end and an inner surface with successive and alternating annular peaks and valleys. The coupling comprises a tubular member having two opposite open ends, defining a geometrical longitudinal axis, having an outer surface, having a first section for insertion within the first corrugated conduit through the open end of this first corrugated conduit, and a second section for insertion within the second corrugated conduit through the open end of this second corrugated circuit. Each of the first and second sections comprises at least one staple comprising a mechanically compliant convex wall slanted toward the open end of the other of the first and second sections. The mechanically compliant convex wall comprises: an elongated wall base connected to the outer surface of the tubular member; a sloping convex surface for sliding over the annular peaks and valleys upon inserting the section of the tubular member in the corrugated conduit through the open end of the corrugated conduit; and a free edge for engaging the inner surface of the corrugated conduit and thereby locking the section of the tubular member inside the corrugated conduit when the mechanically compliant convex wall has been inserted in one of the valleys of the inner surface of the corrugated conduit.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a perspective view of a non-restrictive illustrative embodiment of a coupling for corrugated conduits according to the present invention;

FIG. 2 is a side elevational view of the coupling of FIG. 1, illustrating a method for inserting this coupling within two corrugated conduits in view of coupling these two corrugated conduits;

FIG. 3 is a side elevational view, partially cross sectional, of a pair of corrugated conduits interconnected through the coupling of FIG. 1;

FIG. 4 is a rear perspective view of a non-restrictive illustrative embodiment of an inside cap for corrugated conduit according to the present invention;

FIG. 5 is a front perspective view of the non-restrictive illustrative embodiment of the inside cap for corrugated conduit according to the present invention;

FIG. 6 is a side elevational view of the inside cap of FIGS. 4 and 5, illustrating a method for inserting this cap within one open end of a corrugated conduit in view of closing this corrugated conduit; and

FIG. 7 is a side elevational view, partially cross sectional, of one end of corrugated conduit closed by means of the inside cap of FIGS. 4 and 5.

### DETAILED DESCRIPTION OF THE ILLUSTRATIVE EMBODIMENT

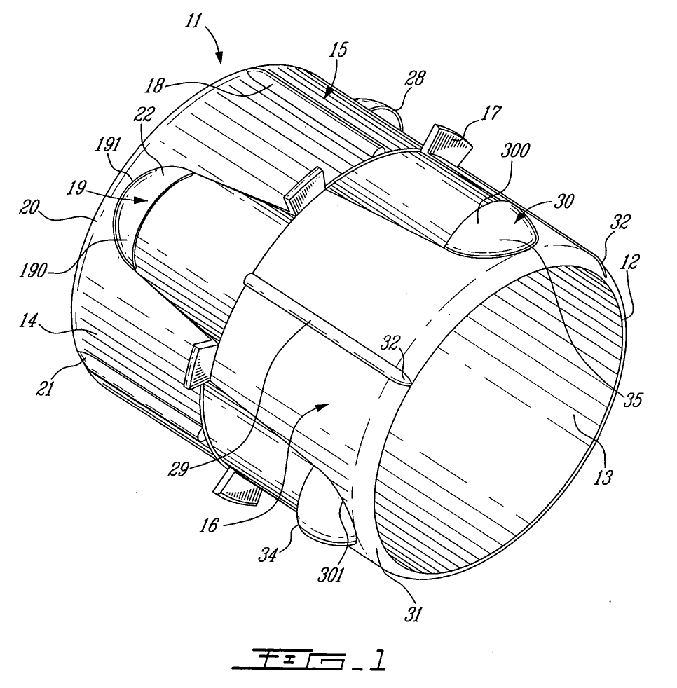

The non-restrictive illustrative embodiment of the coupling for corrugated conduits will now be described with reference to FIGS. 1-3 of the appended drawings.

Referring to FIG. 1, the non-restrictive illustrative embodiment of the coupling according to the present invention is an inside coupling 11 to be inserted within mutually facing open ends of corrugated conduits.

The non-restrictive illustrative embodiment of the coupling according to the present invention is made of plastic material.

The inside coupling 11 according to the illustrative embodiment of FIG. 1 comprises a tubular member, more specifically a cylindrical body 12 with a geometrical longitudinal axis, a smooth inner surface 13 to facilitate flowing of liquid, and an outer cylindrical surface 14.

The cylindrical body 12 is axially divided into first 15 and second 16 sections of equal lengths by means of stoppers such as 17. In the example of FIG. 1, the coupling 11 comprises six (6) stoppers 17 equally distributed on the outer cylindrical surface 14 along a circle centered on the geometrical longitudinal axis of the cylindrical body 12. Also, each stopper 17 is in the form of a tab projecting radially from the outer cylindrical surface 14 between the section 15 and 16. Of course, it is within the scope of the present invention to use a number of stoppers 17 other than six (6) and to use stoppers having a structure different from a radially projecting tab.

Still referring to FIG. 1, section 15 comprises ribs of guidance such as 18 and mechanically compliant staples such as 19.

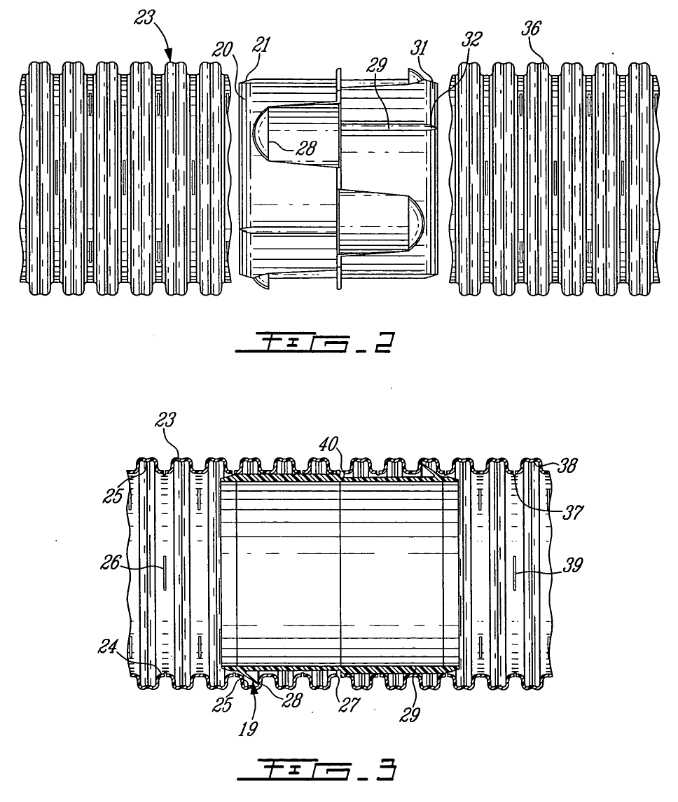

The ribs of guidance 18 comprise three (3) axial ribs circumferentially distributed on the outer cylindrical surface 14 of the cylindrical body 12. The ribs of guidance 18 extend axially between the stoppers 17 and a free open end 20 of the section 15 of the cylindrical body 12. The thickness of the ribs of guidance 18 is so adjusted that section 15 of the cylindrical body 12 fits within the inner diameter of the corrugated conduit 23 (FIG. 2). In the example of FIG. 1, the three (3) ribs of guidance 18 are formed 120° apart from each other on the section 15 of the cylindrical body 12, but it is within the scope of the present invention to use a number of ribs of guidance 18 different from three (3) spaced apart from each other by an angle different from 120°. As illustrated in FIG. 1, the ribs of guidance 18 can be semicircular in cross section but other cross-sectional shapes are possible; a semicircular cross-sectional shape will ensure proper sliding of the ribs of guidance 18 on the inner surface of the corrugated conduit 23.

As better shown in FIG. 2, the free open end 20 of the section 15 of the cylindrical body 12 defines a beveled rim to facilitate insertion of the end 20 through the open end of the corrugated conduit 23. In the same manner, the corresponding end such as 21 of the ribs of guidance 18 are beveled again to facilitate insertion of this end 21 through the open end of the corrugated conduit 23.

The section 15 of the cylindrical body 12 further comprises a set of three (3) staples 19 positioned 120° apart from each other on the outer cylindrical surface 14 along a circle centered on the geometrical longitudinal axis of the cylindrical body 12. As can be seen in FIG. 1, the staples 19 are interleaved with the ribs of guidance 18. More specifically, each staple 19 is centered between two ribs of guidance 18. Of course, other arrangements of staples 19 are possible.

Each staple 19 comprises a mechanically compliant convex wall 190 having substantially the shape of a portion of hemisphere, with a curved elongated wall base 191 connected to the outer cylindrical surface 14 on the section 15 of the cylindrical body 12. The shape of a portion of cone would also be convenient for the mechanically compliant convex wall 190. Each mechanically compliant convex wall 190 also comprises a curved free edge 28 opposite the elongated wall base 191 thereof. As illustrated in FIG. 1, each conical or hemispheric mechanically compliant convex wall 190 is slanted toward the open end 31 of the other section 16 of the cylindrical body 12. Accordingly, each mechanically compliant convex wall 190 defines a sloping convex surface 22 capable of sliding over the inner corrugations (annular peaks and valleys) of the corrugated conduit 23 upon inserting the section 15 within this conduit through the open end thereof.

As illustrated in FIGS. 1 and 2, the curved elongated wall base 191 has two opposite ends and the curved free edge 28 also comprises two opposite ends, the two opposite ends of the curved elongated wall base 191 intersect with the two opposite ends of the curved free edge 28, respectively, and the curved free edge 28 is lying in a plane generally perpendicular to the geometrical longitudinal axis of the cylindrical body 12.

If the coupling 11 is made of plastic material, the staples 19 will be integral with this plastic material; the staples 19 will then be molded in a single piece with the rest of the coupling 11. Also, the nature and thickness of the plastic material will be selected to give a certain flexibility to the mechanically compliant convex walls 190 in order to facilitate the insertion of the section 15 within the corrugated conduit 23.

Referring to FIGS. 2 and 3, the section 15 can be inserted in the corrugated conduit 23 made, for example, of plastic material. The corrugated conduit 23 comprises an inner surface defining successive and alternating annular peaks such as 24 and annular valleys such as 25. In the illustrated example, the inner peaks 24 of the corrugated conduit 23 are perforated with circumferential slits such as 26. Of course, other shapes of perforations 26 could be used, and the coupling 11 could be used with a non-perforated conduit 23.

The beveled rim of the open free end 20 and the beveled ends 21 facilitate insertion of the section 15 through the open end of the corrugated conduit 23. During insertion, the ribs of guidance 18 slide on the annular peaks 24 of the inner surface of the corrugated conduit 23. Also during insertion of the section 15 through the open end of the corrugated conduit 23, the mechanically compliant convex wall 190 deforms to allow the sloping surface 22 to slide over the inner corrugations (peaks 24 and valleys 25) of the conduit 23.

When the free edge 27 (FIG. 3) of the open end of the corrugated conduit 23 abuts the stoppers 17 to limit the course of the section 15 of the cylindrical body 12 within the corrugated conduit 23, the mechanically compliant convex walls 190 of the staples 19 are positioned within a valley 25. Those of ordinary skill in the art will appreciate that the staples 19 are dimensioned to fit in a valley 25, and are axially spaced apart from the stoppers 17 of the coupling 11 to be positioned in a valley 25 when the free edge 27 of the corrugated conduit 23 abuts against the stoppers 17.

When the section 15 of the cylindrical body 12 is positioned within the corrugated conduit 23 as shown in FIG. 3, the mechanically compliant convex walls 190 are positioned in a valley 25. The free edges 28 of the mechanically compliant convex walls 190 then rest on the surface of the valley 25 to prevent the section 15 of the cylindrical body 12 from being withdrawn from the corrugated conduit 23. In other words, the section 15 is locked inside the corrugated conduit 23 by means of the staples 19.

Still referring to FIG. 1, section 16 comprises ribs of guidance such as 29 and mechanically compliant staples such as 30.

The ribs of guidance 29 comprise three (3) axial ribs circumferentially distributed on the outer cylindrical surface 14 of the cylindrical body 12. The ribs of guidance 29 extend axially between the stoppers 17 and the free open end 31 of the section 16 of the cylindrical body 12. The thickness of the ribs of guidance 29 is so adjusted that section 16 of the cylindrical body 12 fits within the inner diameter of a corrugated conduit 36 (FIG. 2). In the example of FIG. 1, the three (3) ribs of guidance 29 are formed 120° apart from each other on the section 16 of the cylindrical body 12, but it is within the scope of the present invention to use a number of ribs of guidance 18 different from three (3) spaced apart from each other by an angle different from 120°. As illustrated in FIG. 1, the ribs of guidance 29 can be semicircular in cross section but other cross-sectional shapes are possible; a semicircular cross-sectional shape will ensure proper sliding of the ribs of guidance 29 on the inner surface of the corrugated conduit 36.

As better shown in FIG. 2, the free open end 31 of the section 16 of the cylindrical body 12 defines a beveled rim to facilitate insertion of the end 31 through the open end of the corrugated conduit 36. In the same manner, the corresponding end such as 32 of the ribs of guidance 29 are beveled again to facilitate insertion of this end 21 through the open end of the corrugated conduit 36.

The section 16 of the cylindrical body 12 further comprises a set of three (3) staples 30 positioned 120° apart from each other on the outer cylindrical surface 14 along a circle centered on the geometrical longitudinal axis of the cylindrical body 12. As can be seen in FIG. 1, the staples 30 are interleaved with the ribs of guidance 29. More specifically, each staple 30 is centered between two ribs of guidance 29. Of course, other arrangements of staples 30 are possible.

Each staple 30 comprises a mechanically compliant convex wall 300 having substantially the shape of a portion of hemisphere, with a curved elongated wall base 301 connected to the outer cylindrical surface 14 on the section 16 of the cylindrical body 12. The shape of a portion of cone would also be convenient for the mechanically compliant convex wall 300. Each mechanically compliant convex wall 300 also comprises a curved free edge 34 opposite the elongated wall base 301 thereof. As illustrated in FIG. 1, each conical or hemispheric mechanically compliant convex wall 300 is slanted toward the open free end 20 of the other section 15 of the cylindrical body 12. Accordingly, each mechanically compliant convex wall 300 defines a sloping convex surface 35 capable of sliding over the inner corrugations (annular peaks and valleys) of the corrugated conduit 36 upon inserting the section 16 within this conduit through the open end thereof.

As illustrated in FIGS. 1 and 2, the curved elongated wall base 301 has two opposite ends and the curved free edge 34 also comprises two opposite ends, the two opposite ends of the curved elongated wall base 301 intersect with the two opposite ends of the curved free edge 34, respectively, and the curved free edge 34 is lying in a plane generally perpendicular to the geometrical longitudinal axis of the cylindrical body 12.

If the coupling 11 is made of plastic material, the staples 30 will be integral with this plastic material; the staples 30 will then be molded in a single piece with the rest of the coupling 11. Also, the nature and thickness of the plastic material will be selected to give a certain flexibility to the mechanically compliant convex walls 300 in order to facilitate the insertion of the section 16 within the corrugated conduit 36.

Referring to FIGS. 2 and 3, the section 16 can be inserted in the corrugated conduit 36 made, for example, of plastic material. The corrugated conduit 36 comprises an inner surface defining successive and alternating annular peaks such as 37 and annular valleys such as 38. In the illustrated example, the inner peaks 37 of the corrugated conduit 36 are perforated with circumferential slits such as 39. Of course, other shapes of perforations 39 could be used, and the coupling 11 could be used with a non-perforated conduit 36.

The beveled rim of the open free end 31 and the beveled ends 32 facilitate insertion of the section 16 through the open end of the corrugated conduit 36. During insertion, the ribs of guidance 29 slide on the annular peaks 37 of the inner surface of the corrugated conduit 36. Also during insertion of the section 16 through the open end of the corrugated conduit 36, the mechanically compliant convex wall 300 deforms to allow the sloping surface 35 to slide over the inner corrugations (peaks 37 and valleys 38) of the conduit 36.

When the free edge 40 (FIG. 3) of the open end of the corrugated conduit 36 abuts against the stoppers 17, the mechanically compliant convex walls 300 of the staples 30 are positioned within an annular valley 38. Those of ordinary skill in the art will appreciate that the mechanically compliant convex walls 300 are dimensioned to fit in a valley 38, and are spaced apart from the stoppers 17 of the coupling 11 to be positioned in a valley 38 when the free edge 30 of the corrugated conduit 36 abuts against the stoppers 17.

When the section 16 of the cylindrical body 12 is positioned within the corrugated conduit 36 as shown in FIG. 3, the mechanically compliant convex walls 300 are positioned in a valley 38. The free edges 34 of the mechanically compliant convex walls 300 then rest on the surface of the valley 25 to prevent the section 16 of the cylindrical body 12 from being withdrawn from the corrugated conduit 36. In other words, the section 16 is locked inside the corrugated conduit 36 by means of the staples 30.

In the position of FIG. 3, the inside coupling 11 interconnects the adjacent open ends of the corrugated conduits 23 and 36.

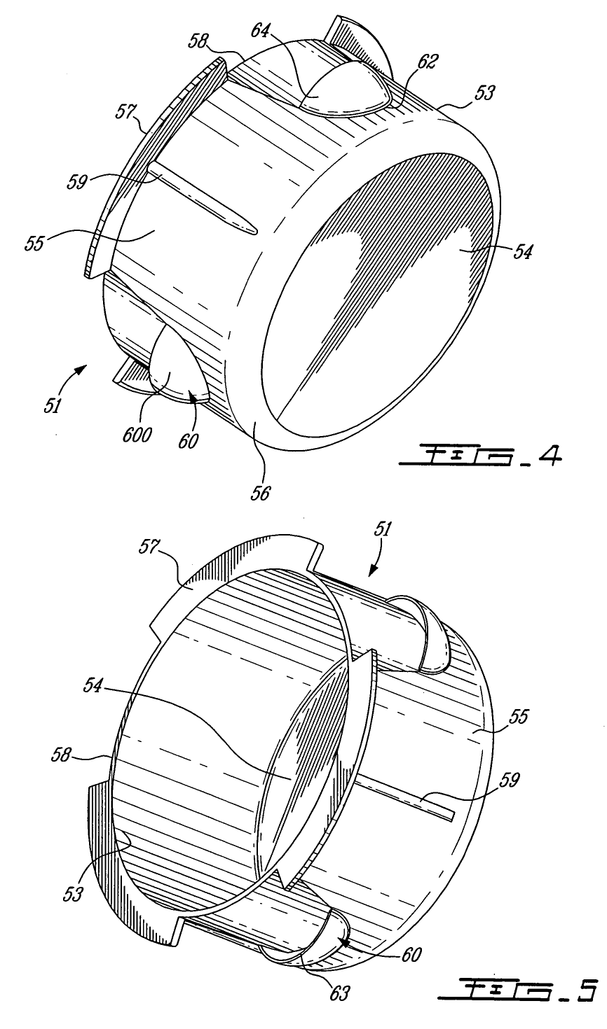

The non-restrictive illustrative embodiment of the cap for corrugated conduit will now be described with reference to FIGS. 4-7 of the appended drawings.

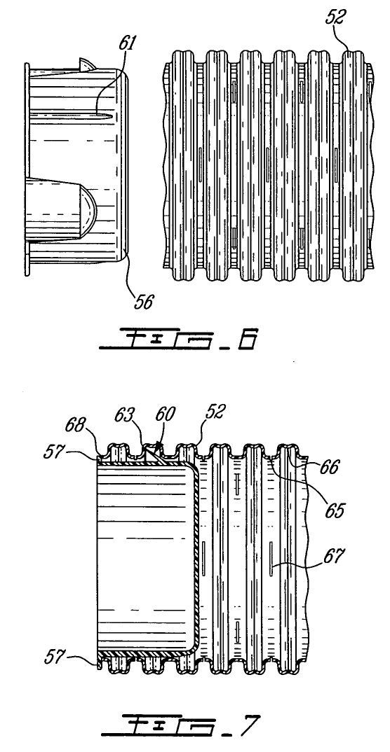

Referring to FIGS. 4 and 5, the non-restrictive illustrative embodiment of the cap according to the present invention is an inside cap 51 to be inserted within one open end of a corrugated conduit such as 52 in FIGS. 6 and 7.

The non-restrictive illustrative embodiment of the cap according to the present invention is made of plastic material.

The inside cap 51 according to the illustrative embodiment of FIGS. 4 and 5 comprises a cylindrical body 53 (tubular member) closed at a proximal end thereof by a wall 54 perpendicular to the geometrical longitudinal axis of the cylindrical body 53. The cylindrical body 53 of the inside cap 51 comprises an outer cylindrical surface 55 defining a rounded annular rim 56 at the annular intersection with the outer surface of the perpendicular wall 54.

As illustrated in FIGS. 4 and 5, the inside cap 51 comprises three (3) stoppers 57 equally distributed (120° apart from each other) along an annular rim 58 at the open distal end of the cylindrical body 53. Each stopper 57 is in the form of a semicircular flange radially extending from the rim 58. Of course, it is within the scope of the present invention to use a number of stoppers 57 other than three (3) and to use stoppers having a structure different from a radially extending, semicircular flange.

Still referring to FIGS. 4 and 5, the inside cap 51 further comprises ribs of guidance such as 59 and staples such as 60.

The ribs of guidance 59 comprise three (3) axial ribs circumferentially distributed on the outer cylindrical surface 55 of the cylindrical body 53. The ribs of guidance 59 extend axially between the stoppers 57 and the rim 58 of the cylindrical body 53. The thickness of the ribs of guidance 59 is so adjusted that the cylindrical body 53 fits within the inner diameter of a corrugated conduit 52 (FIG. 6). In the example of FIGS. 4 and 5, the three (3) ribs of guidance 59 are formed 120° apart from each other on the cylindrical body 53, but it is within the scope of the present invention to use a number of ribs of guidance 59 different from three (3) spaced apart from each other by an angle different from 120°. As illustrated in FIGS. 4 and 5, the ribs of guidance 59 can be semicircular in cross section but other cross-sectional shapes are possible; a semicircular cross-sectional shape will ensure proper sliding of the ribs of guidance 18 on the inner surface of the corrugated conduit 23.

As better shown in FIG. 6, the proximal end 61 of the ribs of guidance 59 adjacent the rounded annular rim 56 is beveled to facilitate insertion of the inside cap 51 within the corrugated conduit 52 through the open end of this corrugated conduit 52.

The inside cap 51 further comprises a set of three (3) staples 60 positioned 120° apart from each other on the outer cylindrical surface 55 along a circle centered on the geometrical longitudinal axis of the cylindrical body 53. As can be seen in FIGS. 4 and 5, the staples 60 are interleaved with the ribs of guidance 59. More specifically, each staple 60 is centered between two ribs of guidance 18. Of course, other arrangements of the staples 60 are possible.

Each staple 60 comprises a mechanically compliant convex wall 600 having substantially the shape of a portion of hemisphere, with a curved elongated wall base 62 connected to the outer cylindrical surface 55 of the cylindrical body 53. The shape of a portion of cone would also be convenient for the mechanically compliant convex wall 600. Each mechanically compliant convex wall 600 also comprises a curved edge 63 opposite to the elongated wall base 62 thereof. As illustrated in FIGS. 4 and 5, each conical or hemispheric mechanically compliant convex wall 600 is slanted toward the open distal end of the cylindrical body 53. Accordingly, each mechanically compliant convex wall 600 defines a sloping convex surface 64 capable of sliding over the inner corrugations (annular peaks and valleys) of the corrugated conduit 52 upon inserting the cylindrical body 53 within this conduit 52 through the open end thereof.

As illustrated in FIGS. 5-6, the curved elongated wall base 62 has two opposite ends and the curved free edge 63 also comprises two opposite ends, the two opposite ends of the curved elongated wall base 62 intersect with the two opposite ends of the curved free edge 63, respectively, and the curved free edge 63 is lying in a plane generally perpendicular to the geometrical longitudinal axis of the cylindrical body 53.

If the inside cap 51 is made of plastic material, the staples 60 will be integral with this plastic material; the staples 60 will then be molded in a single piece with the rest of the inside cap 51. Also, the nature and thickness of the plastic material will be selected to give a certain flexibility to the mechanically compliant convex walls 600 in order to facilitate the insertion of the cylindrical body 53 within the corrugated conduit 52 through the open end thereof.

Referring to FIGS. 6 and 7, the inside cap 51 can be inserted in the corrugated conduit 52 made, for example, of plastic material. The corrugated conduit 52 comprises an inner surface defining successive and alternating annular peaks such as 65 and annular valleys such as 66. In the illustrated example, the inner annular peaks 65 of the corrugated conduit 52 are perforated with circumferential slits such as 67. Of course, other shapes of perforations 67 could be used, and the inside cap 51 could be used with a non-perforated conduit 52.

The beveled free ends 61 and the rounded annular rim 56 facilitate insertion of the cap 51 within the corrugated conduit 52. During this insertion, the ribs of guidance 59 slide on the annular peaks 65 of the inner surface of the corrugated conduit 52. Also during insertion of the cap 51 within the corrugated conduit 52 through the open end thereof, the mechanically compliant convex wall 600 deforms to allow the sloping convex surface 64 to slide over the inner corrugations (annular peaks 65 and valleys 66) of the conduit 52.

When the free edge 68 (FIG. 7) of the conduit 52 abuts the stoppers 57, staples 60 are positioned within a valley 66. Those of ordinary skill in the art will appreciate that the mechanically compliant staples 60 are dimensioned to fit in a valley 66, and are spaced apart from the stoppers 57 to be positioned in a valley 66 when the free edge 68 of the conduit 52 abuts against the stoppers 57.

When the inside cap 51 is positioned within the conduit 52 as shown in FIG. 7, the staples 60 are positioned in a valley 66. The curved free edges such as 63 of the mechanically compliant convex walls 600 then rest on the surface of the valley 66 to prevent the cap 51 from being removed from the conduit 52. In other words, the cap 51 is locked inside the conduit 52 by means of the staples 60.

In the position of FIG. 7, the inside cap 51 closes the open end of the corrugated conduit 52.

Although the present invention has been described in the foregoing specification by means of non-restrictive illustrative embodiments, these illustrative embodiments can be modified at will, within the scope of the appended claims without departing from the nature and spirit of the subject invention.

1. A staple for holding a tubular member within a corrugated conduit, wherein the tubular member comprises an outer surface, the corrugated conduit comprises an open end and an inner surface with successive and alternating annular peaks and valleys, the staple comprises a mechanically compliant convex wall slanted in a direction opposite to a direction of insertion of the tubular member in the corrugated conduit through the open end of said corrugated conduit, and said mechanically compliant convex wall comprises:
an elongated wall base connected to the outer surface of the tubular member;
a sloping convex surface for sliding over the annular peaks and valleys upon inserting the tubular member in the corrugated conduit through the open end of said corrugated conduit; and
a free edge for engaging the inner surface of the corrugated conduit and thereby locking the tubular member inside the corrugated conduit when the mechanically compliant convex wall has been inserted in one of the valleys of the inner surface of the corrugated conduit.

2. A staple as recited in claim 1, wherein the elongated wall base is a curved base.

3. A staple as recited in claim 1, wherein the free edge of the mechanically compliant convex wall is a curved edge.

4. A staple as recited in claim 3, wherein:
the tubular member defines a geometrical longitudinal axis; and
the free edge of the mechanically compliant convex wall is lying in a plane substantially perpendicular to the geometrical longitudinal axis of the tubular member.

5. A staple as recited in claim 2, wherein:
the curved elongated wall base has two opposite ends;
the free edge of the mechanically compliant convex wall is a curved edge having two opposite ends; and
the two opposite ends of the curved elongated wall base intersect with the two opposite ends of the curved free edge of the mechanically compliant convex wall, respectively.

6. A staple as recited in claim 1, wherein the mechanically compliant convex wall presents the shape of a portion of hemisphere.

7. A staple as recited in claim 1, wherein the mechanically compliant convex wall presents the shape of a portion of cone.

8. An inside cap for closing an open end of a corrugated conduit with an inner surface having successive and alternating annular peaks and valleys, the inside cap comprising:
a tubular member defining a geometrical longitudinal axis, having an outer surface, a proximal end and a distal end, closed by a wall perpendicular to the geometrical longitudinal axis, and provided with at least one staple comprising a mechanically compliant convex wall slanted toward the distal end of the tubular member and having:
an elongated wall base connected to the outer surface of the tubular member;
a sloping convex surface for sliding over the annular peaks and valleys upon inserting the tubular member in the corrugated conduit through the open end of said corrugated conduit; and
a free edge for engaging the inner surface of the corrugated conduit and thereby locking the tubular member inside the corrugated conduit when the mechanically compliant convex wall has been inserted in one of the valleys of the inner surface of the corrugated conduit.

9. An inside cap as recited in claim 8, wherein the elongated wall base is a curved base.

10. An inside cap as recited in claim 8, wherein the free edge of the mechanically compliant convex wall is a curved edge.

11. An inside cap as recited in claim 9, wherein the free edge of the mechanically compliant convex wall is lying in a plane substantially perpendicular to the geometrical longitudinal axis of the tubular member.

12. An inside cap as recited in claim 9, wherein:
the curved elongated wall base has two opposite ends;
the free edge of the mechanically compliant convex wall is a curved edge having to opposite ends; and
the two opposite ends of the curved elongated wall base intersect with the two opposite ends of the curved free edge of the mechanically compliant convex wall, respectively.

13. An inside cap as defined in claim 8, wherein the tubular member comprises a plurality of staples distributed on the outer surface of the tubular member along a circle centered on the geometrical longitudinal axis.

14. An inside cap as defined in claim 8, wherein the tubular member further comprises at least one stopper on the outer surface of said tubular member, the open end of the corrugated conduit having a free edge abutting against said at least one stopper upon inserting the tubular member in the corrugated conduit through the open end of said corrugated conduit to limit the course of the tubular member within the corrugated conduit.

15. An inside cap as defined in claim 14, wherein the axial distance between said at least one stopper and said at least one staple is so selected that said at least one staple is located in one of the valleys of the inner surface of the corrugated conduit when the free edge of the open end of the corrugated conduit abuts against said at least one stopper.

16. An inside cap as defined in claim 14, wherein:
the distal end of the tubular member comprises an annular rim; and
said at least one stopper comprises a plurality of semicircular flanges extending radially from and distributed along the annular rim of the distal end of the tubular member.

17. An inside cap as defined in claim 8, further comprising a plurality of axial ribs of guidance circumferentially distributed on the outer surface of the tubular member, said ribs of guidance sliding on the inner surface of the corrugated conduit upon inserting the tubular member in the corrugated conduit through the open end of said corrugated conduit.

18. An inside cap as defined in claim 17, wherein the ribs of guidance comprise at the proximal end of the tubular member ends that are bevelled to facilitate insertion of the tubular member in the corrugated conduit through the open end of said corrugated conduit.

19. An inside cap as defined in claim 8, wherein the perpendicular wall is situated at the proximal end of the tubular member and the outer surface of said tubular wall comprises a rounded annular rim at the annular intersection with the perpendicular wall to facilitate insertion of the tubular member in the corrugated conduit through the open end of said corrugated conduit.

20. A coupling for interconnecting first and second corrugated conduits each having an open end and an inner surface with successive and alternating annular peaks and valleys, comprising:
a tubular member having two opposite open ends, defining a geometrical longitudinal axis, having an outer surface, having a first section for insertion within the first corrugated conduit through the open end of said first corrugated conduit, a second section for insertion within the second corrugated conduit through the open end of said second corrugated circuit, wherein each of said first and second sections comprises at least one staple comprising a mechanically compliant convex wall slanted toward the open end of the other of said first and second sections, and said mechanically compliant convex wall comprises:
an elongated wall base connected to the outer surface of the tubular member;
a sloping convex surface for sliding over the annular peaks and valleys upon inserting the section of the tubular member in the corrugated conduit through the open end of said corrugated conduit; and
a free edge for engaging the inner surface of the corrugated conduit and thereby locking the section of the tubular member inside the corrugated conduit when the mechanically compliant convex wall has been inserted in one of the valleys of the inner surface of the corrugated conduit.

21. A coupling as recited in claim 20, wherein the elongated wall base is a curved base.

22. A coupling as recited in claim 20, wherein the free edge of the mechanically compliant convex wall is a curved edge.

23. A coupling as recited in claim 20, wherein the free edge of the mechanically compliant convex wall is lying in a plane substantially perpendicular to the geometrical longitudinal axis of the tubular member.

24. An inside cap as recited in claim 21, wherein:
the curved elongated wall base has two opposite ends;
the free edge of the mechanically compliant convex wall is a curved edge having to opposite ends; and
the two opposite ends of the curved elongated wall base intersect with the two opposite ends of the curved free edge of the mechanically compliant convex wall, respectively.

25. A coupling as defined in claim 20, wherein each of the first and second sections of the tubular member comprises a plurality of staples distributed on the outer surface of the tubular member along a circle centered on the geometrical longitudinal axis.

26. A coupling as defined in claim 20, wherein the tubular member further comprises at least one stopper on the outer surface of said tubular member between said first and second sections of the tubular member, the open end of the each of said first and second corrugated conduits having a free edge abutting against said at least one stopper upon inserting the corresponding tubular member in the corrugated conduit through the open end of said corrugated conduit to limit the course of the tubular member within the corrugated conduit.

27. A coupling as defined in claim 26, wherein the axial distance between said at least one stopper and said at least one staple of each of said first and second sections is so selected that said at least one staple is located in one of the valleys of the inner surface of the corrugated conduit when the free edge of the open end of the corrugated conduit abuts against said at least one stopper.

28. A coupling as defined in claim 26, wherein said at least one stopper comprises a plurality of tabs projecting radially from the outer surface of the tubular member and distributed along a circle centered one the geometrical longitudinal axis.

29. A coupling as defined in claim 20, wherein each of said first and second sections further comprises a plurality of axial ribs of guidance circumferentially distributed on the outer surface of the tubular member, said ribs of guidance sliding on the inner surface of the corrugated conduit upon-inserting the corresponding section of the tubular member in the corrugated conduit through the open end of said corrugated conduit.

30. A coupling as defined in claim 29, wherein the ribs of guidance comprises at the corresponding open end of the tubular member ends that are bevelled to facilitate insertion of the tubular member in the corrugated conduit through the open end of said corrugated conduit.

31. A coupling as defined in claim 20, wherein each of said first and second sections comprises, at the corresponding open end, a bevelled rim to facilitate insertion of the section of the tubular member in the corrugated conduit through the open end of said corrugated conduit.
